(19) United States
(12) Patent Application Publication
(10) Pub. No.: US 2009/0046146 A1
(43) Pub. Date: Feb. 19, 2009

(54) SURGICAL COMMUNICATION AND CONTROL SYSTEM

(76) Inventor: Jonathan Hoyt, Seattle, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/191,253

(22) Filed: Aug. 13, 2008

Related U.S. Application Data
(60) Provisional application No. 60/955,596, filed on Aug. 13, 2007.

(51) Int. Cl. H04N 7/18; G01C 5/00; G06F 3/033; H04N 5/33

(52) U.S. Cl. 348/143; 33/262; 345/158; 348/164; 345/169; 348/E07.085; 348/E05.024

(57) ABSTRACT

Systems and methods for communication during surgical or other procedures. A system can include a mounting piece adapted to be received on a user's head, and a beam projecting device coupled to the headpiece and configured for selectively directing attention to a particular object or location. A system that can transmit beam locations to a remote screen indicating anatomic locations, and can be used to control medical devices based on where the beam projecting device is directed on a video display.

### CROSS-REFERENCE TO RELATED APPLICATION

The present invention claims the benefit of priority under 35 U.S.C. § 119(e) of U.S. Application No. 60/955,596, filed Aug. 13, 2007 (Attorney Docket No. 027048-000100US), the entire content of which is incorporated herein by reference.

### BACKGROUND OF THE INVENTION

The present invention relates generally to the designation of an item or location of interest, and more particularly to designating devices, systems, and methods that use a beam projecting device. The present invention may be useful in a wide range of applications. In one such application, hands-free designation of an item or location of interest during surgery is provided so as to facilitate communication between surgical staff and/or a third party.

Communication between members of a surgical team or teaching physicians and their medical residents and fellows during a medical procedure such as minimally invasive and percutaneous procedures is important for achieving the best quality patient outcomes. This type of communication can quite be challenging when working in close conditions, such as in a small surgical area on a human body. Typically, these procedures are done through tiny incisions while viewing an image on a display showing the affected area inside of the body. In teaching hospitals, often the resident or fellow will perform the entire procedure under constant direction from the proctoring physician.

Manually pointing to objects, such as tissues, organs, and instruments, during a procedure, or attempting to point with one's hand at a display to indicate a position in question, has been proven to be inaccurate because of the distance between observers and the monitors and because of the extremely minute detail of the anatomy being viewed on the display. Moreover, because both hands are often necessary during a procedure, it is often difficult or dangerous for the physician to remove one hand in order to point. Manual pointing does not usually communicate accurately exactly where one should cut, resect, cauterize, staple, guide, balloon, or stent. As mentioned above, manual pointing requires a physician to take his hand away from the surgical area and sometimes off the handheld instruments that he or she uses to perform a procedure percutaneously, which interrupts the rhythm of the procedure.

Hence, there is a need to improve communication in these situations by allowing physicians to more accurately direct attention to a particular object or location without removing their hands during a surgical procedure.

### BRIEF SUMMARY OF THE INVENTION

The present disclosure is directed generally to the designation of an item or location of interest, and more particularly to designating devices, systems, and methods that use a beam projecting device, or beam source for short. The present invention may be useful in a wide range of applications, such as during surgery to facilitate communication between surgical staff and/or a third party.

More particularly, in one embodiment, a head-mounted designating device is provided that utilizes a resilient mounting piece or head piece, and a beam source attached to the headpiece. The system will typically include activation electronics or a switch to activate the beam source without requiring the use of a user's hands. In accordance with one embodiment, activation occurs upon movement of the user's head, which is detected by a sensor that triggers activation of the beam source on or off.

In further embodiments, the present disclosure provides methods and related systems for the generation of a combined image that includes a generated pointer that has been added to an underlying image which can be broadcast to a remote location. In one example, an image, such as a video image, is generated on a display and a beam source is directed at the display, e.g., to designate a particular object or location on the displayed image. A detector, such as an imaging detector or sensor including a charge-coupled device (CCD), is directed toward an image of the display and the beam source incident on the display. An image processing unit is coupled with the imaging device and has input(s) to receive a signal corresponding to the underlying image being displayed and detected signal from the beam incident on the display. The image processing unit receives the underlying video image as an input, and in turn, can process and output a combined image signal corresponding to the displayed image and the location of the beam incident on the displayed image (e.g., pointer image). Thus, the position of the pointer image is recreated by the processor and shown in the combined video image and is representative of the location of the beam reflection on the primary video display, with combined image data capable of being streamed to a remote location and image (e.g., real time video image) generated on a remote display. Another embodiment allows the imaging detector and beam source to independently, or in conjunction with another switch or switches be utilized to control equipment or devices in the OR.

For a fuller understanding of the nature and advantages of the present invention, reference should be made to the ensuing detailed description taken in conjunction with the accompanying drawings. The drawings represent embodiments of the present invention by way of illustration. Accordingly, the drawings and descriptions of these embodiments are illustrative in nature and not restrictive.

### BRIEF DESCRIPTION OF THE DRAWINGS

FIG. 1 illustrates a beam source coupled to a wearable mounting piece according to an embodiment of the present invention.

FIG. 2 shows a beam source coupled to a mounting piece for further coupling to an eye shield according to another embodiment of the present invention.

FIG. 3 illustrates a beam source coupled to a wearable head piece and a removable eye shield, according to an embodiment of the present invention.

FIG. 4 shows a beam source with a mounting piece for removable attachment to a user's eyewear, and a housing with electronics for activation of the beam source, according to another embodiment of the present invention.

FIG. 5 shows a beam source mounted on a user's eyewear and exemplary positioning of electronics for activation of the beam source.

FIG. 6 illustrates a user wearing a communication system, according to an embodiment of the present invention.

FIG. 7 is a flowchart schematically illustrating a method for overlaying an image with a generated pointer image, according to an embodiment of the present invention.

FIG. 8A is a front view that graphically illustrates the designation of a feature or location on a displayed image, and the capture of the location of a beam reflection by an imaging device, according to an embodiment of the present invention.

FIG. 8B is a side view of the graphical illustration of FIG. 8A, and illustrates relative positions of an imaging device mounted to an image display, according to an embodiment of the present invention.

FIG. 8C is a simplified graphical illustration of an image processing unit, according to an embodiment of the present invention.

FIG. 9 schematically illustrates a communication system, according to an embodiment of the present invention.

FIG. 10A is a front view that graphically illustrates the designation of a feature or location on a displayed image, and the capture of the location of a beam reflection by an imaging device, according to an embodiment of the present invention.

FIG. 10B is a front view that graphically illustrates the designation of a feature or location on a displayed combined image that includes a generated pointer image, and the capture of the location of a beam reflection by an imaging device, according to an embodiment of the present invention.

FIG. 11 is a flowchart schematically illustrating a method for overlaying an image with a generated pointer image, according to an embodiment of the present invention.

FIG. 12 is a side view that graphically illustrates the designation of a feature or location on an item of interest, and the capture of an image and the location of a beam reflection, according to an embodiment of the present invention.

FIG. 13 schematically illustrates a communication system, according to an embodiment of the present invention.

FIG. 14 schematically illustrates an image processing unit, according to an embodiment of the present invention.

FIG. 15 illustrates an exemplary method for the system that allows a beam source to be broadcast as a converted computer generated pointer overlay at a remote location.

FIG. 16 shows the aforementioned system as in FIG. 15 further showing two way telestration facilitated from the primary procedure monitor to a remote location.

FIG. 17 shows the aforementioned system as in FIG. 16 allowing for two way communication and telestration from procedure room to procedure room.

FIG. 18 shows an overview of how the beam source and combined beam detector system could be utilized as a device control mechanism in the procedure room.

FIG. 19 shows an diagram example of how the graphic user interface could appear to allow the user to control medical devices in the procedure room.

FIG. 20 shows another diagram example of how the graphic user interface could appear to allow the user to control medical devices in the procedure room

FIG. 21 shows a side view illustration of the beam detector detecting the beam source.

FIG. 22 shows a front view illustration of the beam detector detecting the beam source.

FIG. 23 shows the aspect correction that could take place through a combination of hardware and software.

### DETAILED DESCRIPTION OF THE INVENTION

The present invention provides devices, systems, and methods for facilitating communication through the designation of an item or location of interest. Although the present invention may have a wide range of applications, it may be useful for facilitating communication between members of a medical team, such as a surgical team, one or more teaching physicians, teaching physicians and students/residents/fellows, and the like. When team members are more engaged and can communicate more clearly and accurately, it serves to improve the quality of patient care. In another embodiment, systems may be useful as a hands free controlling mechanism for procedural devices. The present invention may find use in a wide variety of medical applications and will include various surgical applications or procedures, including during minimally invasive and percutaneous procedures. Certain embodiments of the present invention can be categorized into three main groups; specifically “hands free” designation; an image overlaid with a generated pointer image that can be broadcast to a remote location; and a control system that could command and control medical procedural devices.

### “Hands Free” Designation

Embodiments of the present invention can provide for “hands free” designation. As many procedures are done while requiring use of both of hands of the surgeon or medical professional, and/or viewing an image on a display showing the affected area inside of the body, accurately indicating an object or portion of an object can be difficult. Currently, communications as to a point of reference or anatomical landmark typically include attempts to point with one's hand at (e.g., at an image display such as a video display) to indicate the position in question. This has been proven undesirable and, often grossly inaccurate, for a number of reasons, including, e.g., unavailability of a physician's hand(s), distance from the targets or the image display, minute detail of the anatomy being viewed, therefore an anatomic target cannot always be accurately pointed at with one's finger, etc. The present invention will improve communication in these situations by allowing a user to wear a small, head-mounted beam projecting device (or beam source for short), such as a laser pointer, that can be particularly directed at a given point of reference. Additionally, operation of the system will typically be “hands-free” and can be turned on and off without requiring further use of the user's hand(s), freeing the hands for use for other tasks of the procedure. In one example, the beam source can be turned on and off with a slight but deliberate tilt of the head to one side, though other hands-free means of activation will be available.

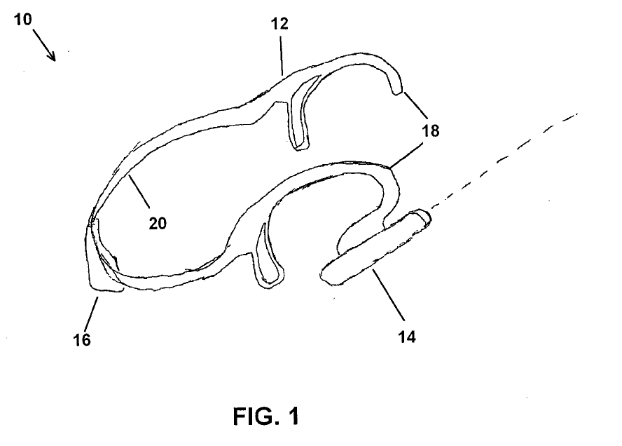

Referring to FIG. 1, a headpiece assembly 10 according to one embodiment of the present invention is illustrated. Headpiece assembly 10 includes a mounting piece 12 that is adapted to be received by a user's head, a beam source 14 coupled to the mounting piece 12, and electronics 16 for controlling activation of the beam source 14. The mounting piece 12 can include ear-receiving portions 18 shaped to at least partially fit or bend around to the user's ears. The mounting piece 12 can further include a connecting portion 20 that extends between the ear-receiving portions 18, which, when worn by a user extends around the back of the user's head. Electronics 16 for controlling activation of the beam source 14 can be positioned at various locations on the mounting piece 12 or various locations on the head-piece assembly 10 in general. For example, electronics 16 can be incorporated or coupled to the beam source 14 itself so as to form a sort of one piece beam-source/switch assembly (not shown). Alternatively, electronics 16 can be positioned on the connecting portion 20 of the headpiece assembly 10 extending between the ear-receiving portions 18 of the mounting piece 12, as illustrated in FIG. 1.

Various beam sources can be utilized in systems of the present invention and will typically be light-weight and sized for attachment to a headpiece assembly and for comfortable wearing and use by the user. In general, a beam source can project any variation of visible or invisible light, laser or electromagnetic radiation. For example, a beam source can project a beam that includes a range of electromagnetic frequencies, such as frequencies within the visible light spectrum, and or frequencies outside the visible light spectrum, such as infra-red frequencies or ultra-violet frequencies. A beam source that projects one or more visible frequencies is referred to herein as a light source. Light sources can include green, blue, red lasers and the like, or can include a combination of such which, for example, may be alternatively selected and used. Color beams can be selected for use by a particular member or members of a team (e.g., surgical team), for example where it may be desired to avoid confusion between users or to identify a particular user or type of user (e.g., surgeon, assistant, resident, etc.) by beam color. Power sources can be battery sources or other sources, such as plug-in, solar, rechargeable, etc. Beams typically will be of the lowest strength needed to conserve battery power and/or diminish risk of eye damage or temporary vision impairment due to inadvertent contact with a person's eye. In some cases, beams can be directed at a monitor or graphical interface, and therefore beam brightness can be selected to reduce unwanted reflection from the target but bright enough to be visible for identification of the intended point of reference.

A beam source can be mounted in one or more positions on a headpiece and may be movable or adjustable while mounted so as to allow for different beam emitting angles. For example, a beam source can have a rotation capability while mounted in order to change or select angles of the beam. Angle can be about parallel with a user's straight-ahead line of sight or can be off angle relative to vector, including angled upward or downward. For example, an upward angled position of the beam may be desired where a target such as a video display is positioned at a height higher than the user's head or where the user desires to face a downward angle (e.g., toward the surgical site) but reference a target at a height higher than the surgical sight. In some instances, however, a downward angle of the beam can be selected, for example, for reference a target below the user's head and may help prevent unnecessary head bending and/or tilting. An angle (e.g., downward angle) can be selected to avoid unwanted direction of the beam, such as toward faces of others nearby.

Various types of electronics and/or configurations can be utilized for hands-free controlled activation of the beam source. In one example, activation electronics can include a motion or angle activated switching mechanism. Such switches can include mercury activated switches or those that are digital in nature such as an inclinometer or accelerometer. Electronics, as mentioned above, can be positioned in various locations on the headpiece or elsewhere on the assembly, and will be in communication with the beam source. Electronics can be hard-wired to the beam source or communication can be wireless (e.g., radio communication, RF, Bluetooth™, and the like). In one embodiment, motion or angle change activates the beam source and can include head movement such as a tilt at a selected angle (e.g., 30-45 degrees). The beam source can be configured for activation for a predetermined amount of time (e.g., 3-5 seconds), after which the beam source shuts off, and/or the beam source can be configured for deactivation upon a second motion, such as a second head tilt. Other types of activation switches can include, for example, voice activated switches, foot activated switch, or activated by another body part—e.g., elbow activated with elbow contact with a torso worn band or device (e.g., waistband), infrared motion switch that triggers activation due to motion, and the like. Electronics or the beam source itself can further optionally include additional features such as automatic shut off after an amount of activation time.

Mounting pieces can include various embodiments, and are not limited to any particular shape and/or design. Mounting pieces or headpieces can further optionally be designed for use with other components or articles in addition to the beam source and activation electronics described above. For example, a system of the invention can be further optionally coupled with other usable components such as microphones or other communication devices or electronics, as well as various types of eyewear, headwear, surgical items or garments, and the like. Headpieces can include attachment or anchor points (e.g., hooks, holes, loops, buttons, Velcro, and the like), for example, for other devices, surgical tools, surgical garments or masks, etc. and can therefore include combined functionality or combined use devices. Any one or more pieces or components of the present invention can be provided in re-usable or disposable form.

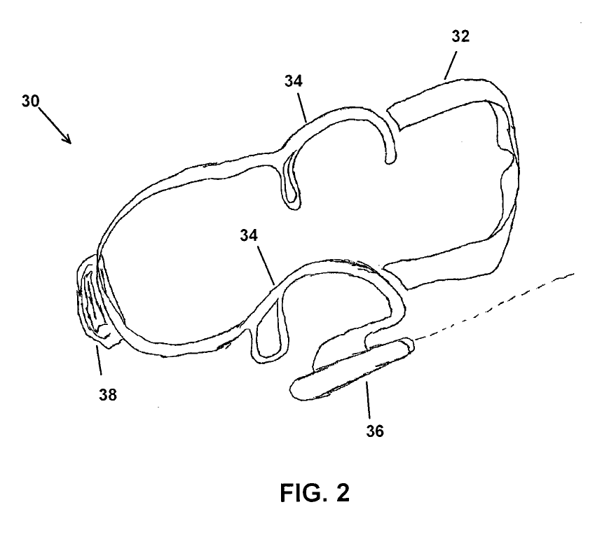

A system of the present invention can be further coupled with other devices or objects. As illustrated in FIG. 2, for example, a headpiece assembly 30 can be coupled with protective eyewear 32, including of the type often worn during surgical procedures. FIG. 2 illustrates a mounting piece 34 with a mounted beam source 36 and electronics 38 for activating the beam source 36. An attachable eye shield 32 (e.g., plastic shield, radiation blocking shield, etc.) can be attached to the headpiece assembly 30, including by attachment to one or more portions of the mounting piece 34.

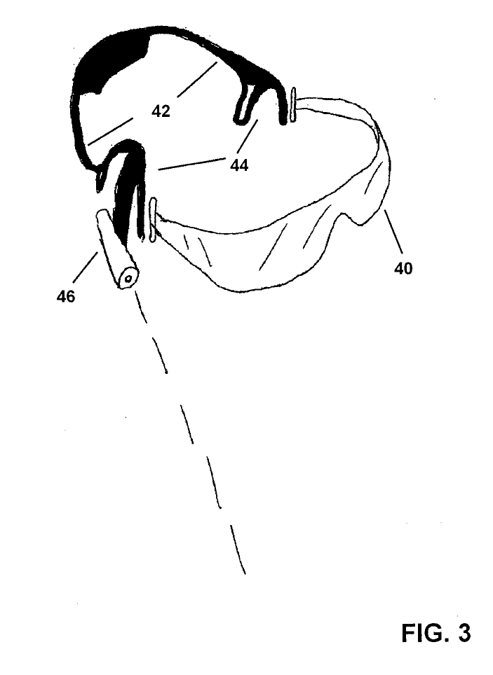

Referring to FIG. 3, a system of the present invention including an attachable and disposable eye shield 40 is shown according to another embodiment of the present invention. A removable eye shield 40 is attachable to the mounting piece 42 at locations proximate to ear-receiving portions 44 and the mounted beam source 46.

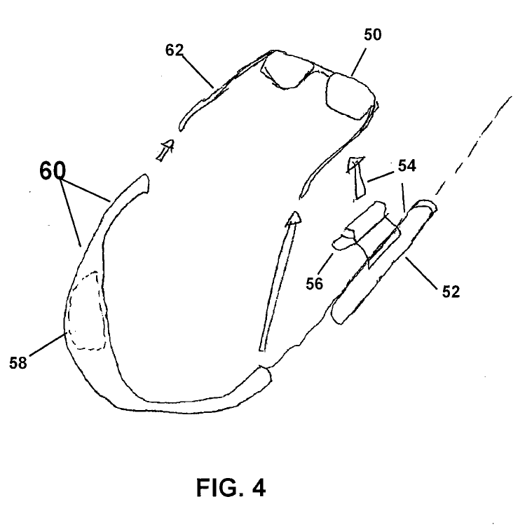

In another embodiment, the present system can include components that can be assembled with a user's eyewear, such as a user's glasses. FIG. 4 illustrates system components attachable to a user's glasses 50, such as surgical glasses or ordinary eyeglasses. The beam source 52 includes a mounting member 54 for connecting the beam source 52 to the eyeglasses 50, which can include a clamp 56 or any other attachment means. Beam source activation electronics 58 are also included and can be coupled with the headpiece assembly 60, including being mounted to the beam source 52, the eyeglasses 50 (e.g., opposing arm 62 of eyeglasses 50 opposite arm to which beam source 52 is mounted), or a combination. The electronics 58 can be placed in a housing that can be attached to the beam source 52 and/or eyeglasses 50 at one or more locations, and will be in communication with the beam source 52 (e.g., wired, wireless, etc.) for activation.

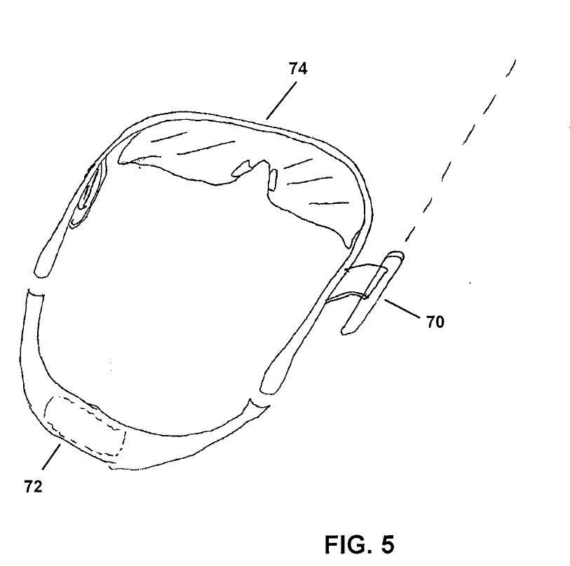

Referring to FIG. 5, another embodiment is shown with a beam source 70 and activation electronics 72 being assembled with a piece of eyewear 74. Thus, the present invention can include a kit that can be provided to a user for assembly and use. The kit can include one or more components of a system as described herein. For example, a kit can include a mountable beam source, which can be attached by the user to a mounting piece such as a specifically designed headpiece, eyewear or the user's own eyewear or eyeglasses. The kit will also include activation electronics 72 as described above, which can be provided coupled to the beam source 70 or provided as disconnected pieces. The kit will also include literature and/or instructions for assembly of components of the kit, as well as information on use and product care. A kit can include various types of packaging and arrangements, and can be optionally included with various components and articles.

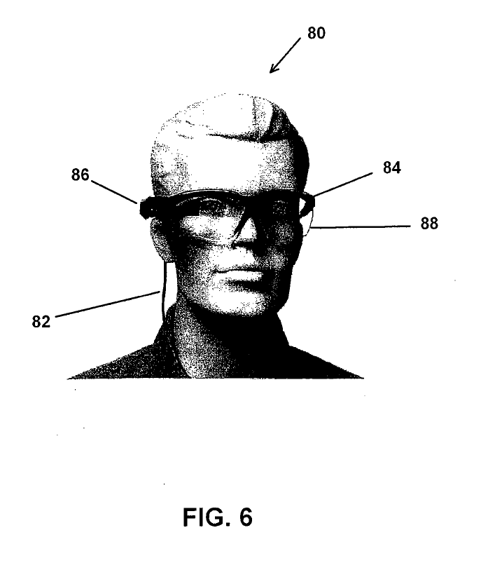

Referring to FIG. 6, a user 80 wearing a communication system 82 according to one embodiment of the present invention is illustrated. The system includes a headpiece assembly 84 positioned on the user's head, with a side mounted beam source 86 and activation electronics. User eyewear 88 is included in the headpiece assembly 84.

Image Overlaid with a Generated Pointer Image

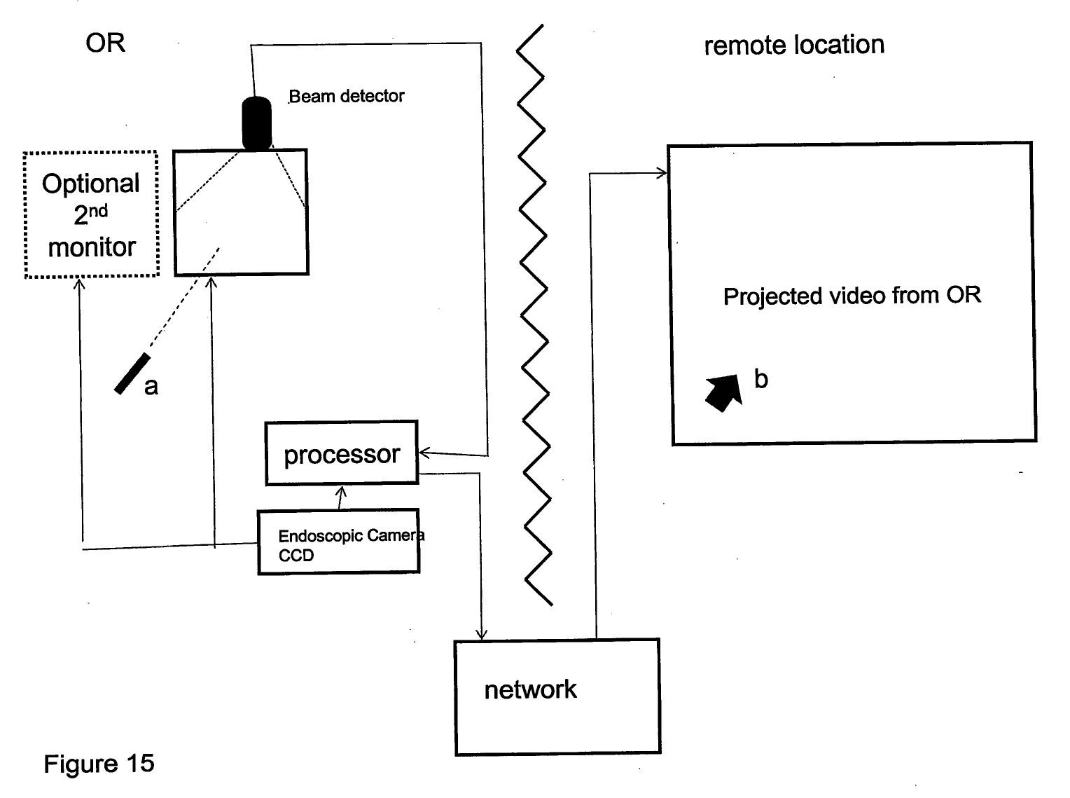

In some instances, it may be desirable for a user of a designating or pointing device as described herein to reference an image (e.g., video image) displayed on a monitor or other display device. Further, it may be desirable to communicate designation or referencing by the user to another clinician or audience at a remote location or in the instance where the user is instructing and proctoring a clinician from a remote location (known as teleproctoring) Thus, in another aspect, the present invention includes systems and methods for overlaying an image, such as a video image, with designation or reference points from the user oriented pointing device or beam source, and display the combined/overlayed image at a remote location (see, e.g., FIG. 15). Such methods would allow, for example, doctors, instructors, medical professionals (e.g., surgeons or members of a surgical team), to utilize the beam source to point out anatomic landmarks on a video screen during a procedure, further to convey information and/or instruct remotely and have the beam source incident on an image converted to a computer animated pointer overlay that could be broadcast along with the original procedural video signal. The “overlay” would allow for a corresponding computer generated pointer to move over the image being broadcast in direct correlation to the movement of the laser pointer beam in relation to the video image being seen by the user. In one embodiment, such a system could include mounting a detector or special beam detecting sensor (e.g., charged coupled device) that would include a compact video camera (or multiple cameras) that would be mounted to the monitor and aimed back at the procedural display. The video camera would be equipped with the proper infrared filter so it is capable of isolating the illumination wavelength of the beam source, in this case, a laser pointer from the rest of the image. The beam source emits a unique reflected wavelength versus the remainder of light being reflected from the video image displayed, which is detected by the beam detecting sensor in this scenario. Such laser beam sources and compact cameras can include those currently commercially available. Referring back to the embodiment described above, the entire captured image would be sent to an image processing device, such as computer processor coupled with a storage medium including, e.g., instructions, proprietary software, and/or algorithm(s), which in this embodiment, separates the beam movements from the rest of the video image to create a computer animated pointer overlay which could be added to the original video image, allowing the audience to see the original image plus the computer generated pointer. The system would have in its software and hardware the means to lock and calibrate the animated pointer relative to the original beam so that the location representation is completely accurate. Therefore, when a user, such as surgeon speaking to an audience or/teaching in the operating room, is using the beam source an audience can see the pointer on a remote display present as a computer generated pointer/indicator, such as a dot, circle, cross hair, or arrow overlaid with the image being referenced by the user. In some situations, it would be beneficial for the system to allow input and output communication between two locations—meaning that the observer in a remote location could also use the same system or another method of marking anatomic locations on a display, which then could be broadcast to the surgeons original screen so that two way communication can be achieved for the purposes of bettering patient care.

Systems and methods as described would advantageously allow for easy instruction and communication between remote locations, and provides the inherent benefit of not requiring a video overlay on the primary procedural screen, or the display which is more proximal to the laser pointer and being referenced by the beam source operator. In the surgical context, for example, it is commonly desirable to have the best image possible in an operating room, and existing systems offering a digitized mouse pointer overlaid and added to the image being referenced at the source display (e.g., display specifically being referenced by the surgeon) typically causes decreased image quality. In other words, this type of “front end” overlay at the source display can add noise to video image, thereby resulting in degradation of image quality. Such existing front end overlay systems have not been largely adopted for reasons of added noise and image quality degradation, as well as due to lack of practical usability—e.g., such systems can be cumbersome and difficult to use as the mouse pointer is activated and moved by voice command. Typically many voice commands are needed to locate the mouse pointer in the correct location using these systems. When a surgeon, for example, uses a voice activated pointer overlay, he often must cease medical instruction to use repeated voice commands to make slight movements of a pointer up, down, left, or right which is inefficient.

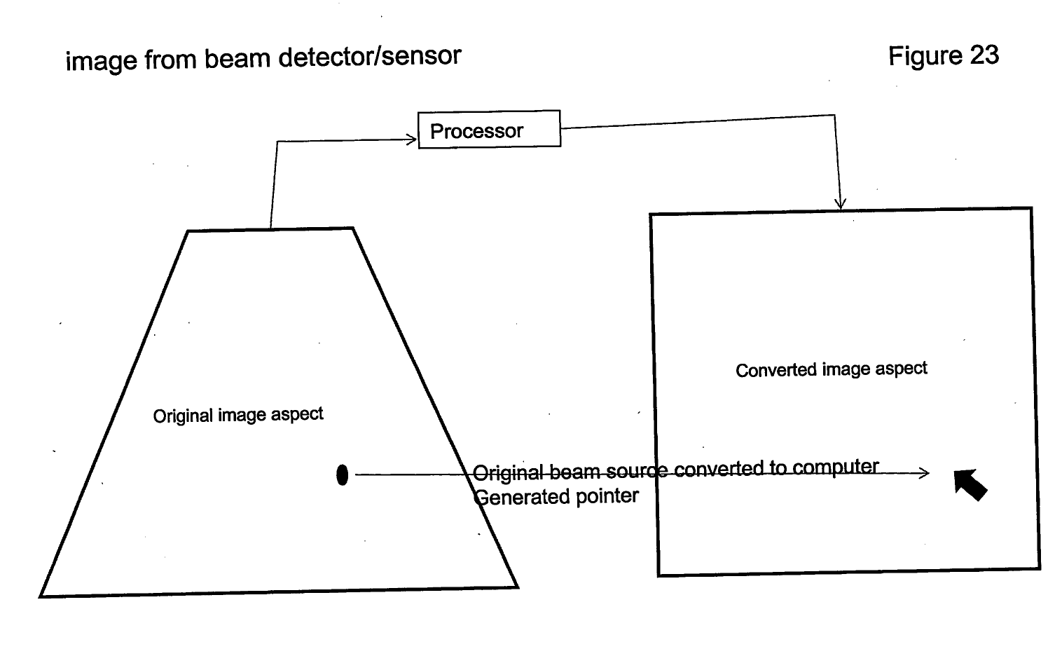

Returning to the systems of the present invention, as mentioned, systems will include a device for detecting beam positioning on the image being referenced. The device or detector can include a compact video camera (e.g., including a CCD) or a near infrared camera that is specially mounted to the system. The detector, or camera would be small and could be mounted to any surgical video monitor in the operating room or location of the beam source user. If the user/surgeon is accustomed to switching sides of the patient and using two different monitors, a second system could be set up to allow this on a secondary display. The camera would be on a mounting bracket at the top edge of the screen, that would be long enough to extend the camera beyond the front of the screen so it could be aimed down and back at the screen. Commercially available “lipstick” cameras ensure a small footprint and easy mounting. If necessary, the camera image processor can be hidden away (e.g. above the ceiling) and connected to the camera head in order to create a minimal footprint and a more aesthetic result. As mentioned previously, in one embodiment the camera would be tuned to differentiate the beam source light from the illuminated light of the rest of the monitor (e.g., light from the displayed image itself). The system would allow for calibration to correct for situation specific differences in distance to the monitor, precise angle of the camera in relation to the monitor. Calibration would require the user to temporarily overlay the combined video image on the primary procedural monitor, and in a practice setting or prior to starting a procedure, the system would be designed to allow the user to see the beam source, i.e. laser beam and the computer regenerated pointer concurrently to make sure that the regenerated pointer accurately represents the location of the laser pointer. The calibration screen could then be removed allowing the procedure to begin and allowing the user to use the system with only the procedural video image on the screen, hence maintaining the highest image quality during the procedure. The information coming from the camera would be sent to a computer either through a wired or wireless system. The camera could be aimed at the monitor in such a way that the field of view would be specially designed to compensate for the angle—e.g., since the camera is not shooting the monitor from straight on, but rather would be at an extreme angle, hardware or software would be in place to correct for this (see, e.g., FIG. 23).

A system of the invention will further include an image processor or processing unit, which could be located on an equipment cart, or hidden away inside the room on a shelf or in an equipment rack. It could be connected with cabling through the ceiling and internal to the equipment boom arms (if the hospital employ these types of booms) or a cable across the floor if they use wheeled carts for their equipment but choose not to locate the processor unit on the wheeled cart. The processing unit may be in the form of a computer or box containing electronics (e.g., computer, processor, storage medium, etc.) and could be configured to receive the signal from the procedural video source such as an endoscopic camera, microscope, fluoroscopic c-arm, etc., either wired or wirelessly. The processing unit would be loaded with the correct processors and software to convert the information coming from the camera to something that correlates to a standard 4:3 or 16:9 image. In other words, the camera and computer with software system uses an algorithm to take the original information from the camera, which may appear trapezoidal, due to the angle, and “correct” it for this angle so that it truly does correspond with the users movements in relation to the video image (See FIG. 23).

The angle at which the detector/camera is mounted and fixed from the monitor is predetermined to make sure that the beam pointer is most accurately translated to a computer generated pointer in the correct coordinates with relation to the video content on the screen with minimal calibration needed. This is accomplished using a mounting system that fixes the distance from the monitor to the camera based on the size and model of the monitor. Although the system can be designed to work on any screen, large or small, the system typically only needs to be compatible with monitor models most commonly used for medical procedures.

The detector/camera will be powered, and could be coupled to a power source (e.g., battery, AC source, etc.). Where the monitor is mounted, for example, on a boom arm, the power cable can be run through the boom arm, back to the power source. Where the monitor is on a wheeled cart, the power cord is run to the power strip located on the wheeled cart and powered when the wheeled card its plugged in. The mounting system would be generic enough to allow ease of installation to any of the commonly used monitor systems. The mounting could optionally incorporate a “hood” or other light blocking means that would block ambient light from washing out the monitor image. However, this would be optional and not required for the systems proper operation in the capacity previously described.

The receiving processor can receive the signal from the beam detecting device and apply processing in order to separate the beam source location from the rest of the image. The processor would be built from typical computer components (i.e. CPU, Motherboard, RAM, Operating System, System Sofware, Graphics Card, Power Supply, etc.). In one embodiment, the proprietary software is trained to detect the brightest part of the image, which would be the beam source dot and extract it from the entire image using a motion capturing technique. In this embodiment, the beam source movements are mapped in real time to a computer animated overlay recreating the beam source on x and y coordinates with a computer generated pointer. In another embodiment, the system uses pattern recognition algorithms to search for the reflected beam source dot. By removing all other image information, the overlay would be created containing only the beam source dot, which could be regenerated or animated as an arrow, cross hair, circle, or any desired shape. Another embodiment uses identifies the beam source and isolates it due to it being of unique coloring not found in the procedural video image. In yet another embodiment, the beam source uses ultrafast pulsing which allows the system (software and hardware) to be programmed to identify and isolate the dot because of these puling characterstics, then separate it from the remaining image information. Once the software/operating instructions applied the correct algorithm to generate the overlay of the computer generated pointer, the system would receive the original video image as an input, then add in the pointer overlay with the ability to send the resulting mixed image (procedural video image plus animated pointer overlay) out as an output using commonly used signal types (i.e., DVI, SDI, HD-SDI, Composite, S-Video, HDMI, RGB-HV, RGB, etc.). The design of the system would allow for minimal added singal to noise ratio and minimal, if not non-existent, signal degradation. Since the beam source/pointer device is something that may not be activated full-time, the software can be included to detect when there is no beam source activated, and in turn, not project a combined image, but project the original procedural image without a pointer overlay. In turn, when the beam source is activated, the processor would then be programmed to transmit the resultant mixed video image.

Systems and methods of the present invention will be suitable for a variety of uses and will be useful in numerous situations. For example, surgeons who are accustomed to teaching to a remote classroom or auditorium during live surgery would have a system to allow them to broadcast a pointer during surgery—e.g., for instruction and the like. In other (e.g., cath lab/radiology) types of procedure areas, this would be a convenient way to communicate to and from a remote location. An interventional radiologist or cardiologist can perform a procedure while a staff member communicate back and forth to determine the best treatment option. This staff member will enter notes into the chart (electronically) and capture digital pictures. Often times, the physician and this staff member(s) discuss what the physician is seeing, and may even discuss types and sizes of balloons, stents, or catheters that will be needed to “fix” the problem (e.g., diseased vessels, CAD, PVD, etc.). The inventive system would allow the physician to wear and use pointing device and the staff member, e.g., working in the control room and looking at the same image but on a different video screen, to see the pointer. It would be possible to have a similar system or a touch screen at the remote location to allow the non-sterile clinician to annotate or point to certain locations that would be then transmitted to the primary procedural display which would enhance communication thus improving patient care. The system could be operable in pointing mode, such that movement of the pointer as seen by the user is conveyed in corresponding timing to a viewer at a remote location, or in a telestration or annotation mode, where pointing signal is processed and displayed as an image lasting on a remote display. For example, telestration can allow drawing, circling, and the like, with the pointer with the resulting image lasting a few seconds or more on the processed image. The length of time for markings to remain on the screen could be preprogrammed or the system could be designed where a head tilt could erase the telestrated mark up so that the user could reannotate another section.

Thus, the present systems and methods provide advantageous displaying of an image, such as a video image, so as to facilitate communication regarding the image, for example, to direct a person's attention to a certain feature or location within the image. Clear and unambiguous designation of an item or location of interest helps to minimize the potential for miscommunication with the remote person or can minimize mistakes when an attending physician is training another clinician by proctoring him through the procedure. For example, during certain surgical procedures, communication between members of a surgical team may include directing attention to a particular area of the patient shown in the displayed image.

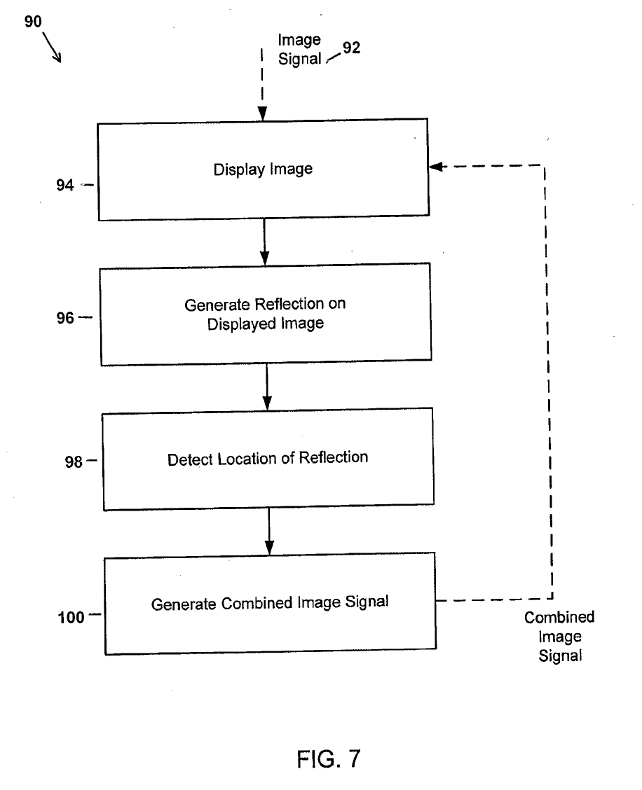

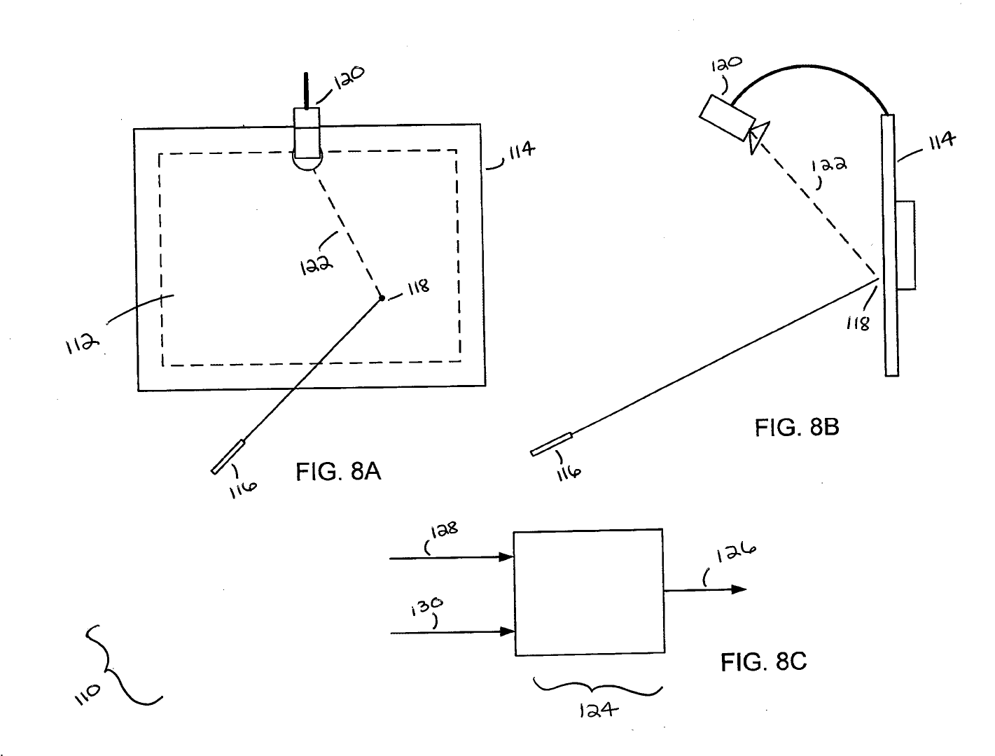

Turning now to FIG. 7, a flowchart is presented that schematically illustrates a method 90 for generating a combined image signal 92 corresponding to a combined image that includes a generated pointer image that may provide for clear and unambiguous designation of an item or location of interest. In step 94, an image is displayed that includes an item or location of interest. The displayed image can be any number of images, such as a static image or a video image. The displayed image can be previously captured or recorded, or can be displayed as it is being captured in real time. The displayed image can be displayed in any number of ways, such as on a video monitor, on a projection screen, or the like. An image signal can be input into a display device to display the image. In step 96, a beam source, such as a laser pointer, is used to generate a reflection on the displayed image so as to designate an item or location of interest. In step 98, the location of the beam reflection relative to the image is detected. In one embodiment, as will be discussed further below with reference to FIGS. 8A and 8B, an imaging device, such as a charge-coupled device (CCD) image sensor, can be used detect the location of the beam reflection relative to the displayed image. In another embodiment, the displayed image and beam reflection are captured, such as by a video camera, and the location of the beam reflection relative to the displayed image is determined using image processing of the recorded image. In step 100, a combined image signal corresponding in appearance to a original image with the beam location/indication on the screen is generated. The combined image includes the displayed image overlaid with a generated pointer image located as determined in step 98. The combined image signal can be used to display the displayed image in step 94. By using the combined image signal in step 100, the resulting location of the generated pointer image is displayed and can be used to adjust the location of the beam reflection so as to position and calibrate the generated pointer image as desired. Displaying the combined image in step 100 provides for visible feedback to the person directing the beam source thereby allowing the person to see the position of the generated pointer image and to adjust the position of the generated pointer image as desired by adjusting the position of the beam reflection.

FIGS. 8A, 8B, and 8C graphically illustrate the steps of method 110. FIGS. 8A and 8B is a front view and side view respectively of a displayed image 112 that can be displayed on a image display 114, such as a video display. A beam source 116, such as a laser pointer, generates a beam reflection 118 at an item or location of interest on the displayed image 112. In most cases, a person would orient beam source 116 so as to locate the beam reflection as desired. A detector or imaging device 120, such as a charge-coupled device (CCD) image sensor, is coupled with the image display 114 so as to substantially fix the imaging device 120 relative to the displayed image 112. Although the imaging device 120 can be physically coupled directly to the image display 114, it is not necessary. It is sufficient that the imaging device 120 and image display 114 are held relative to each other and that the imaging device 120 is oriented relative to the displayed image 112 so that the field of view of the imaging device 120 covers appropriate regions, preferably all, of the displayed image 112. Although the imaging device 120 is shown located generally above the displayed image 112, it should be appreciated that other orientations can be used.

Although the beam reflection 118 produces reflected radiation that travels outward from the beam reflection 118 in many directions, the reflection path 122 shown depicts the reflected beam as seen by the imaging device 120. The imaging device 120 can be an array sensor device, such as charge-coupled device (CCD) image sensor, that generates a signal that indicates the orientation of the beam reflection 118 relative to the imaging device 120. Alternatively, the imaging device 120 can capture both the displayed image 112 and the beam reflection 118 for subsequent processing to determine the location of the beam reflection 118.

FIG. 8C shows a simplified graphical illustration of a image processing unit 124 that can be used to generate a combined image signal 126 corresponding to a combined image that includes the displayed image 112 overlaid with a generated pointer image. An underlying image signal 128, such as a video signal, can be received by the image processing unit 124. The image processing unit 124 can receive a location signal 130 from the imaging device 120. Where the imaging device 120 captures both the displayed image 112 and the beam reflection 118, the underlying displayed image signal 128 can be omitted. The image processing unit 124 outputs the combined image signal 126 for display of the combined image. The combined image can be displayed in real-time, or can be recorded for delayed display. The combined image signal 126 can also be input into the image device 120 so that the displayed image 112 is the combined image 126, thereby providing feedback to the person directing the beam source 116 regarding the position of the generated pointer image.

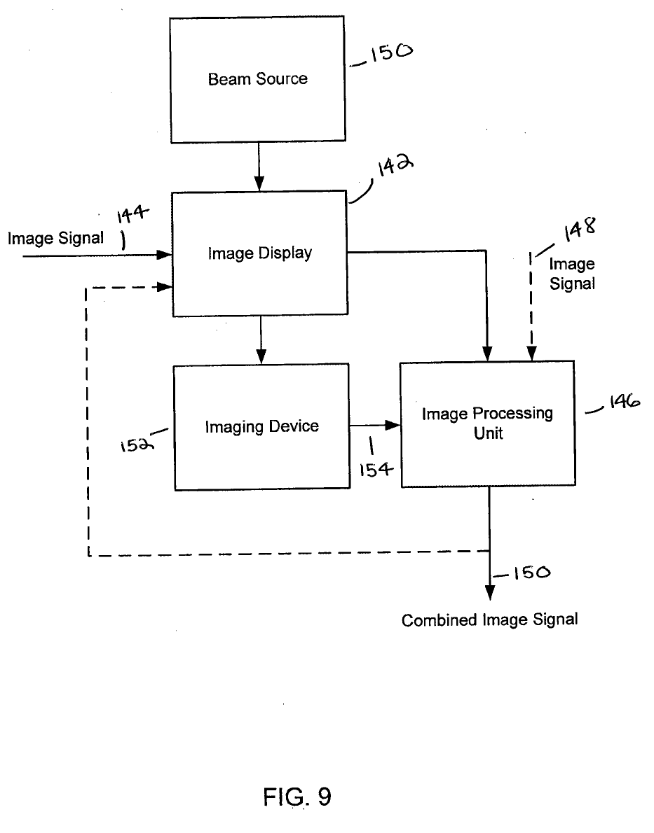

FIG. 9 schematically illustrates a communication system 140 that can be used to practice method 90 of FIG. 7. Communication system 140 includes an image display 142 that can be used to display an image, such as a video display for the display of video images, or any kind of display that can be used to display an image. An image signal 144 can be provided to the image display 142 in any number of ways. For example, a video signal corresponding to a video image can be obtained from any number of image sources, such as a video camera that is capturing the video image in real time, or such as a video recording device. In another example, the image processing unit 146 can be supplied with an image signal 148, and the combined image signal 150 generated by the image processing unit 146 can be input into the image display. In another example, a person can simply provide the image display with the image, such as by mounting a picture, or graphic, or the like. A beam source 150 can be used to generate a beam reflection at a item or location of interest on the image displayed. An imaging device 152, such as a charge-coupled device (CCD) image sensor or video camera, can be used to image the displayed image and the beam reflection and supply a signal 154 to an image processing unit 146. The image processing unit can receive an image signal 148 corresponding to the displayed image without the beam reflection. The imaging processing unit 146 can produce a combined image signal from the original image and the regenerated pointer corresponding to a combined image that includes the original displayed image overlaid with a generated pointer image (FIG. 15).

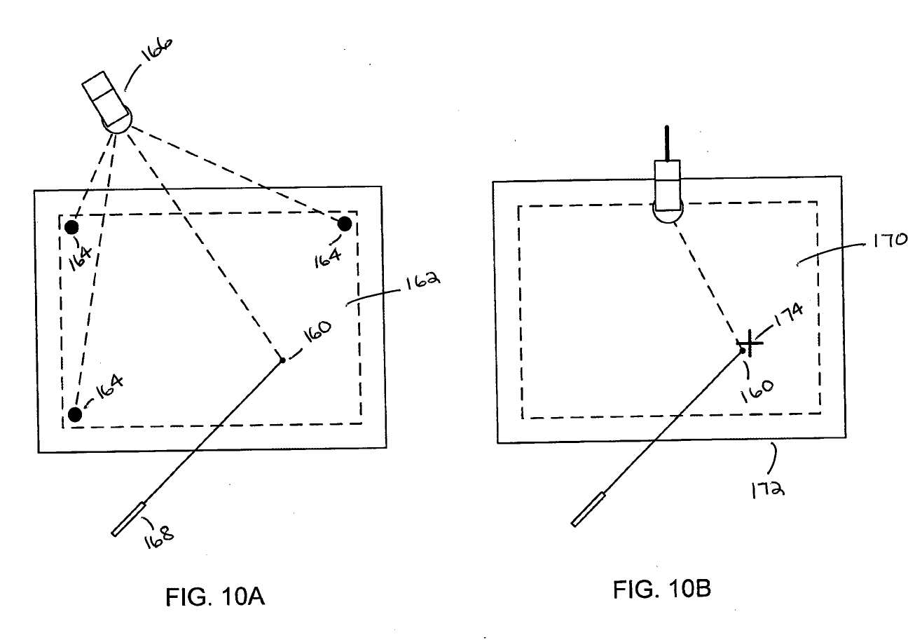

FIG. 10A graphically illustrates an alternative approach that can be used to detect the location of a beam reflection 160 relative to a displayed image 162. As shown, the displayed image 162 includes three orientation features 164 that can be detected by the imaging device and used to calculate the precise location of the beam incident on the screen of the displayed image. The imaging device 166 captures a combined image that includes: the displayed image 162; the three orientation features 164; and the beam reflection 160 generated by the beam source 168. The imaging device 166 can then transfer the combined image to the image processing unit, which can use the locations of the orientation features 164 and the beam reflection 160 to locate the generated pointer image to be overlaid on the displayed image 162. Accordingly, it should be appreciated that a variety of approaches can be used to coordinate the location of the beam reflection with its corresponding position on the displayed image.

FIG. 10B graphically illustrates the display of the combined image 170 on an image display 172. A generated pointer image 174 is shown slightly offset from the beam reflection 160. The slight offset shown is primarily for illustration purposes, as the generated pointer image 174 can be located at substantially the same location as the beam reflection 160. It should be appreciated that any relative offset between the position of the beam reflection 160 and the position of the generated pointer image 174 can be used as desired. In use, the position of the generated pointer image 174 is typically responsive to the position of the beam reflection 160, thereby providing the ability to move the generated pointer image 174 within the displayed combined image 170 as desired.

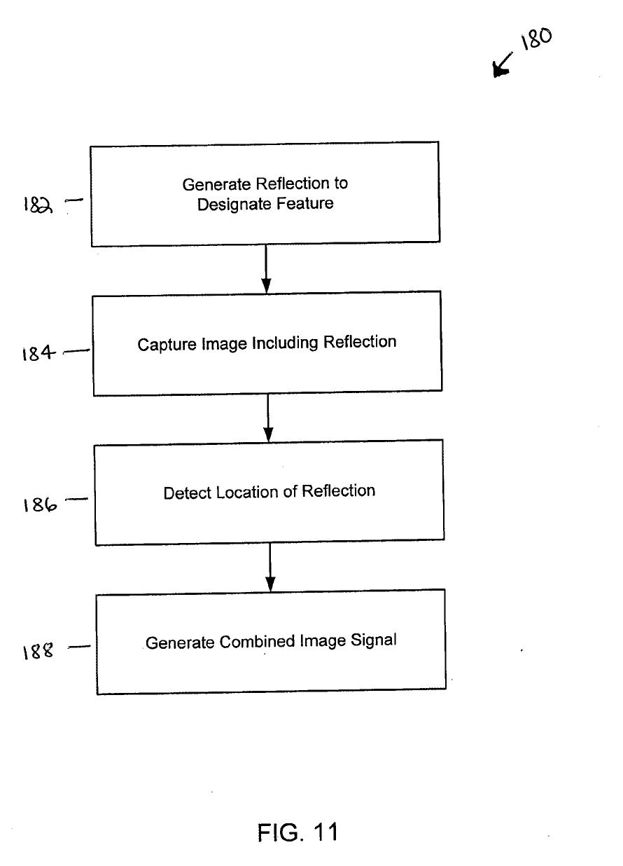

Turning now to FIG. 11, a flowchart is presented that schematically illustrates an alternate method 180 for generating a combined image signal corresponding to a combined image that includes a generated pointer image. In step 182, a beam source, such as a laser pointer, is used to generate a beam reflection to designate a feature or location on an item of interest. For example, a laser pointer can be used to generate a reflection from a feature on an internal organ of a patient undergoing surgery. In step 184, an image is captured that includes the item of interest and the generated reflection. In step 186, the location of the reflection within the capture image is detected. Finally, in step 188, a combined image signal is generated that corresponds to the captured image overlaid with a generated pointer image positioned to correspond to the position of the reflection.

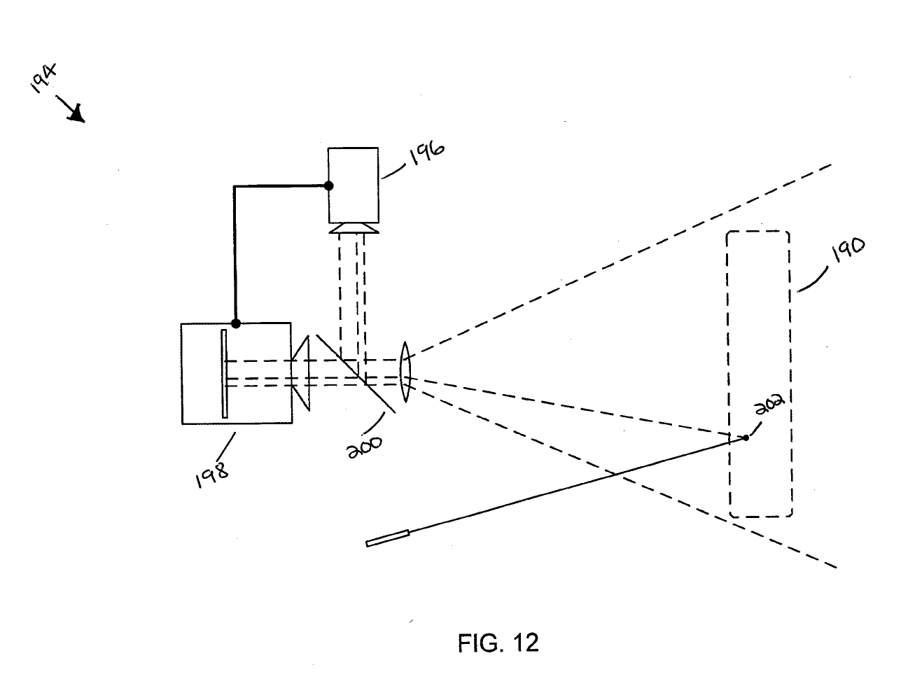

FIG. 12 graphically illustrates an embodiment that provides for the designation of a feature or location on an item of interest 190, and the capture of an image and the location of the designating beam reflection 192 relative to the captured image. As shown, a combined imaging device 194 is shown and includes an imaging device 196, such as an array sensor device like a charge-coupled device (CCD) image sensor, and an image capture device 198, such as a video camera or the like. The combined imaging device 194 can include a beam splitter 200 so that both the imaging device 196 and the image capture device 198 can image the item of interest 190 from the same perspective. The imaging device 196 can be used to sense the relative location of the beam reflection 202 relative to the captured image. The item of interest 190 can be any number of items. For example, the item of interest 190 can be any item that can be viewed by the combined imaging device 194, such as an internal organ of a patient during surgery, or any displayed image that can be viewed by the combined imaging device 194. The combined imaging device 194 can be coupled with an image processing unit for the generation of a combined image signal that includes the captured image and an overlaid generated pointer image. The combined imaging device 194 can be integrated with an image processing unit or surgical endoscopic camera system for a more compact design.

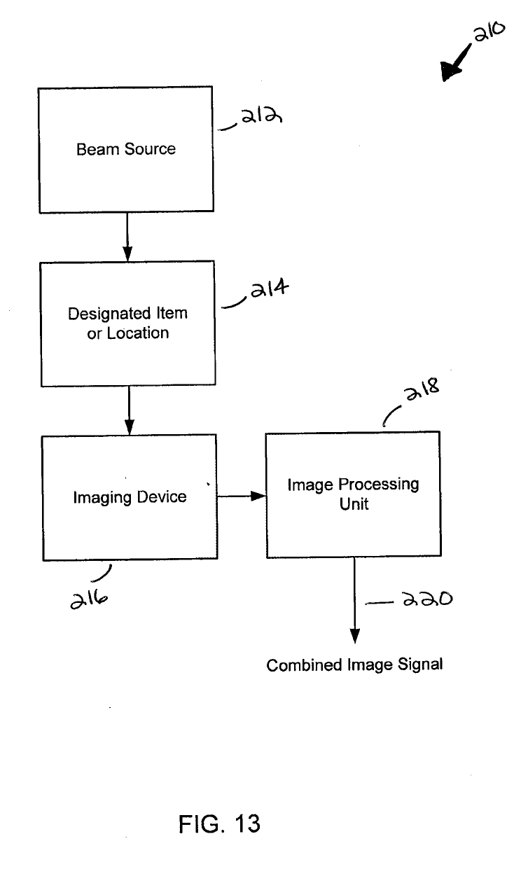

FIG. 13 schematically illustrates a communication system 210 that can be used to practice method 180 of FIG. 11. Communication system 210 includes a beam source 212, such as a laser pointer, that can be used to generate a beam reflection from a designated item or location 214. An imaging device 216 can be used to image the designated item or location 214 and the beam reflection. The imaging device 216 can be any number of devices. For example the imaging device 216 can be a simple camera or a video camera. As another example, the imaging device 216 can be a combined imaging device, such as combined imaging device 194 depicted in FIG. 12. The imaging device 216 can be coupled with an image processing unit 218 so as to communicate the captured combined image. The image processing unit outputs a combined image signal 220 corresponding to an image of the designated item or location 214 overlaid with a generated pointer image positioned to correspond with the location of the beam reflection. The imaging device 216 and the image processing unit 218 can be located within an integrated unit for a more compact design.

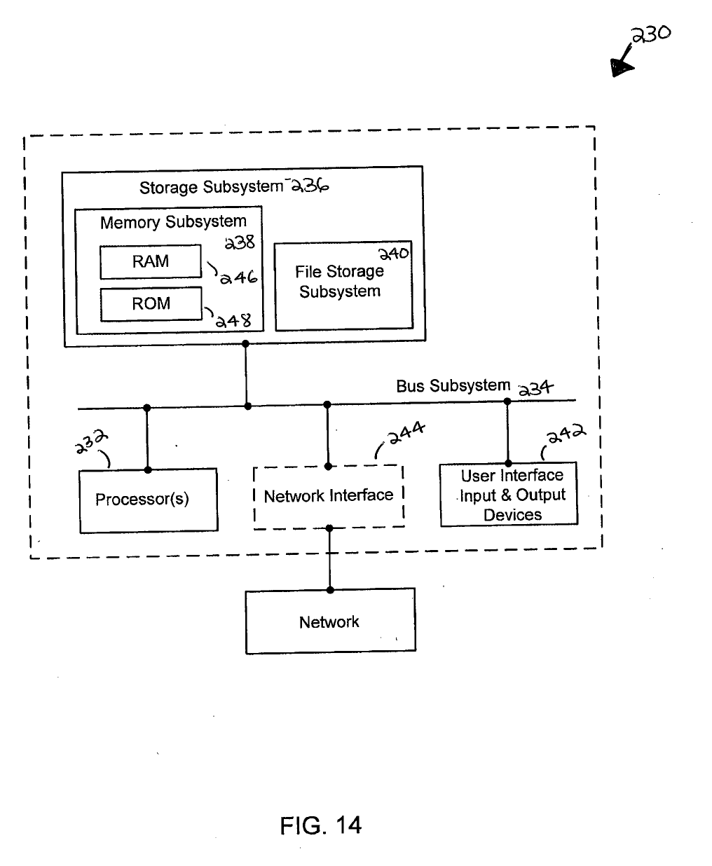

FIG. 14 is a simplified block diagram of an embodiment of an image processing unit 230 for generating a combine image signal as discussed above. Image processing unit 230 typically includes at least one processor 232 which communicates with a number of peripheral devices via bus subsystem 234. These peripheral devices typically include a storage subsystem 236 (memory subsystem 238 and file storage subsystem 240), a set of user interface input and output devices 242, and a network interface 244 to an outside network, such an intranet, the internet, or the like. The outside network can be used to transmit the combined image signal to a display device, such as a remotely located video display.

The user interface input devices may include items such as a keyboard, a pointing device, scanner, one or more indirect pointing devices such as a mouse, trackball, touchpad, or graphics tablet, or a direct pointing device such as a touch screen incorporated into the display, or any combination thereof. Other types of user interface input devices, such as voice recognition systems, are also possible.

User interface output devices typically include a printer and a display subsystem, which includes a display controller and a display device coupled to the controller. The display device may be a cathode ray tube (CRT), a flat-panel device such as a liquid crystal display (LCD), or a projection device. The display subsystem may also provide non-visual display such as audio output.

Storage subsystem 236 maintains the basic programming and data constructs that provide functionality for the image processing unit embodiment. Software modules for implementing the above discussed functionality are typically stored in storage subsystem 236. Storage subsystem 236 typically comprises memory subsystem 238 and file storage subsystem 240.

Memory subsystem 238 typically includes a number of memories including a main random access memory (RAM) 246 for storage of instructions and data during program execution and a read only memory (ROM) 248 in which fixed instructions are stored. In the case of Macintosh-compatible personal computers the ROM would include portions of the operating system; in the case of IBM-compatible personal computers, this would include the BIOS (basic input/output system).

File storage subsystem 240 provides persistent (non-volatile) storage for program and data files, and may include a hard disk drive and/or a disk drive (with associated removable media). There may also be other devices such as a CD-ROM drive and optical drives (all with their associated removable media). Additionally, the system may include drives of the type with removable media cartridges. The removable media cartridges may, for example be hard disk cartridges. One or more of the drives may be located at a remote location, such as in a server on a local area network or at a site on the Internet's World Wide Web.

In this context, the term “bus subsystem” is used generically so as to include any mechanism for letting the various components and subsystems communicate with each other as intended. With the exception of the input devices and the display, the other components need not be at the same physical location. Thus, for example, portions of the file storage system could be connected via various local-area or wide-area network media, including telephone lines. Similarly, the input devices and display need not be at the same location as the processor, although it is anticipated that the present invention will most often be implemented in the context of PCs and workstations.

Bus subsystem 234 is shown schematically as a single bus, but a typical system has a number of buses such as a local bus and one or more expansion buses (e.g., ADB, SCSI, ISA, EISA, MCA, NuBus, or PCI), as well as serial and parallel ports. Network connections are usually established through a device such as a network adapter on one of these expansion buses or a modem on a serial port. The client computer may be a desktop system or a portable system.

FIG. 15 illustrates a schematic of how the system would be used to communicate one way to a remote location and in turn, the general signal chain and communication flow between components. Specifically the beam detector is shown receiving the input of the beam source (a), the processor filters the beam location from the entire image and sends an overlay of a regenerated pointer location to a remote display (regenerated pointer labeled “b”).

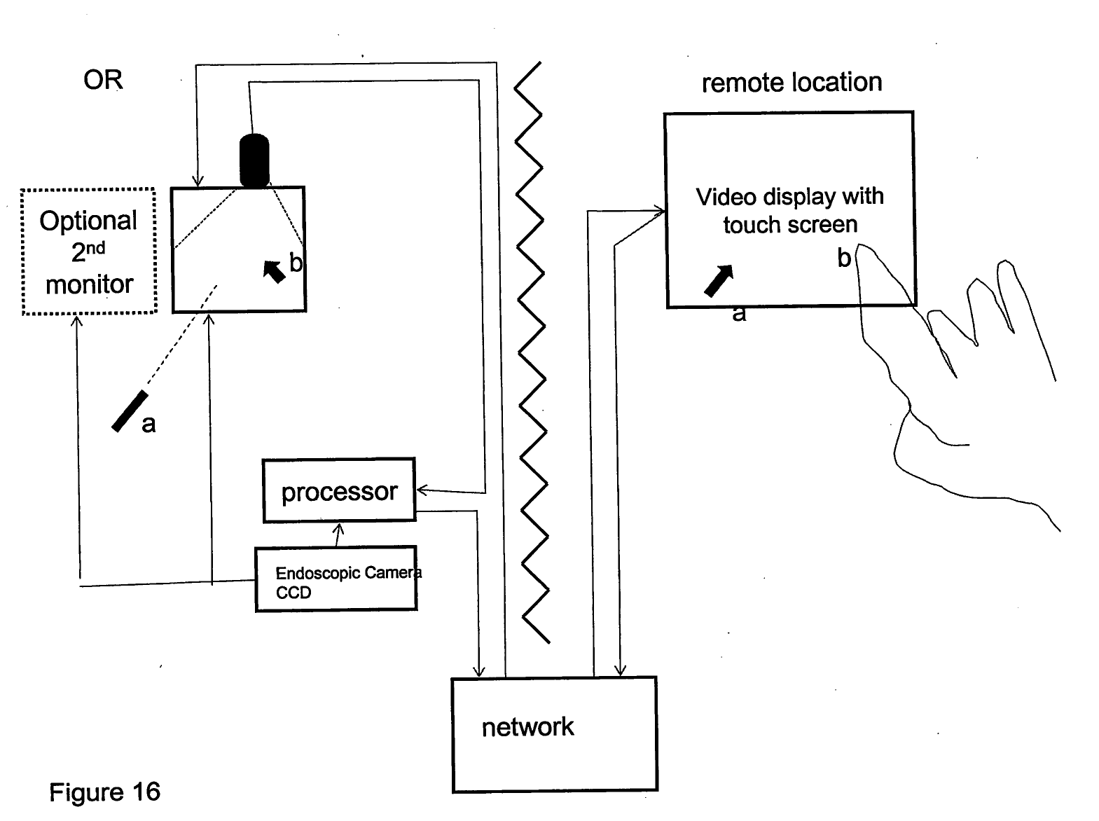

FIG. 16 illustrates a system similar to that illustrated in FIG. 15 but showing the design of a system enabling two way transmission. This figure shows the remote location also with the ability of inputting information specific to anatomic locations that is transmitted back to the primary procedural screen. In this scenario the input at the remote location is shown using a touch screen display.

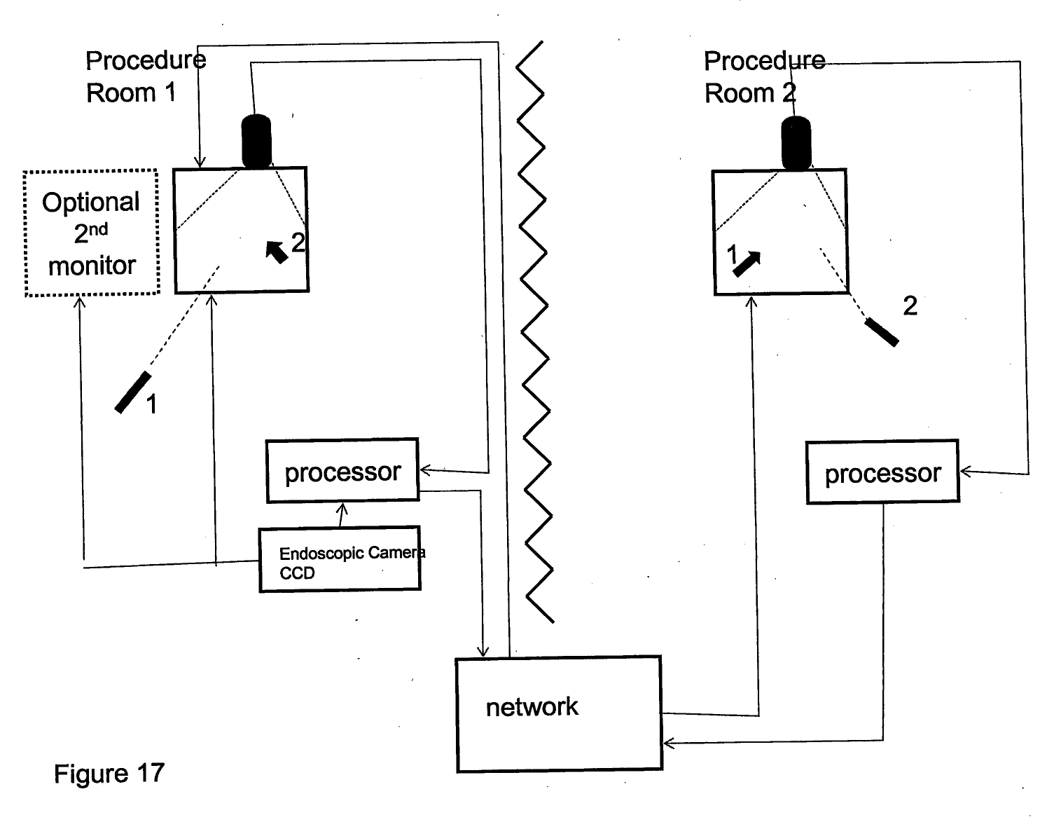

FIG. 17 illustrates two way communication similar to the aforementioned example, only both users are sterile and using the hands free communication system outlined in this document. This would be typical when a clinician in one procedure room Wants to consult with a user in another procedure room. Pointer 1 in procedure room 1 corresponds and is translated into regenerated pointer 1 in procedure room 2. And conversely, pointer 2 in procedure room 2 corresponds and is translated into regenerated pointer 2 in procedure room 1.

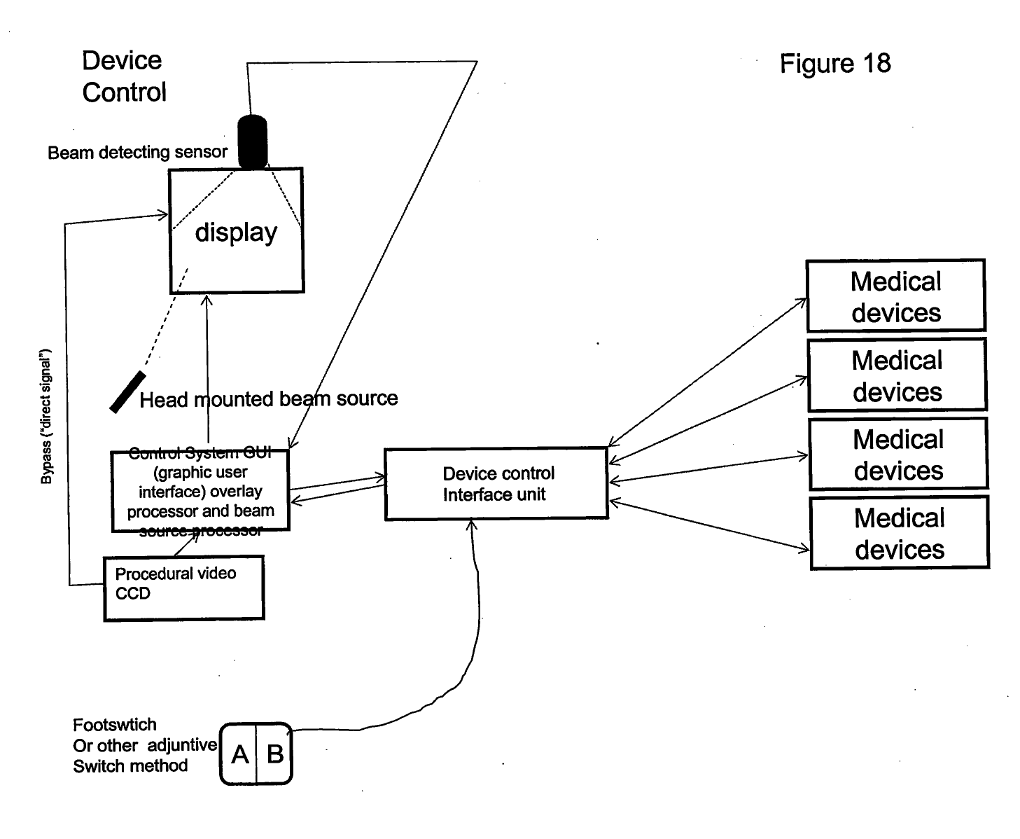

FIG. 18 illustrates a system configured and wired to allow for device control with the overlay generated on the primary procedural display. The footswitch shows a method to allow the user to click on command icons that would appear on the screen while the beam source is used to aim at the particular desired command icon to be clicked. The control system GUI and device control processor communicate and paramaters are changed using the system.

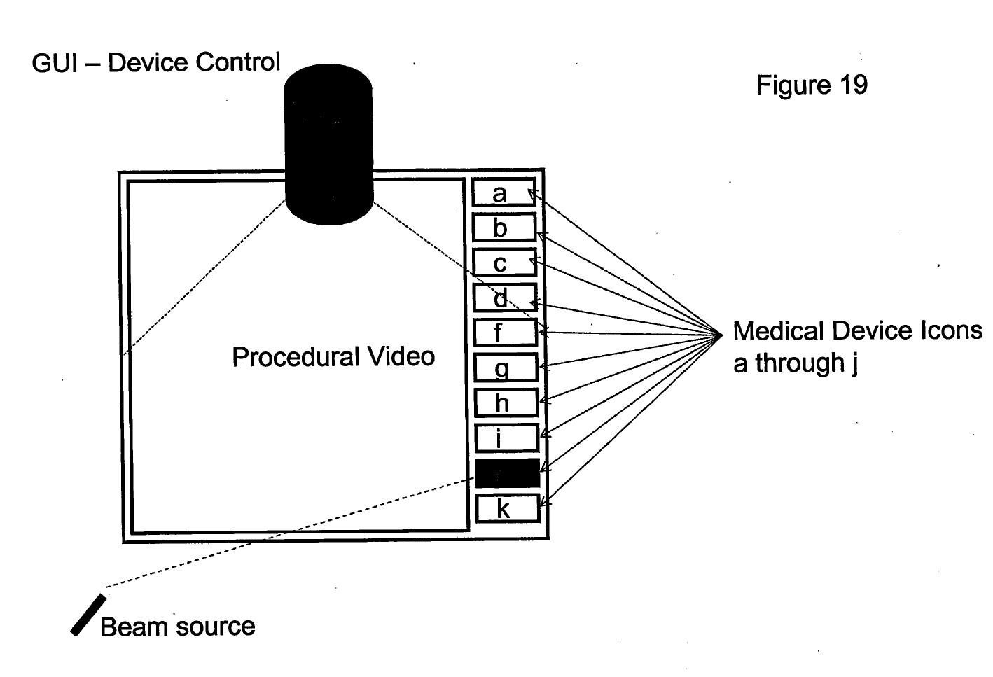

FIG. 19 illustrates an example of how the graphic user interface could be overlayed on to the primary procedural image screen. The side bar could illuminate buttons that when activated using the method described in FIG. 18, would allow for drilling into device controls for that desired device.

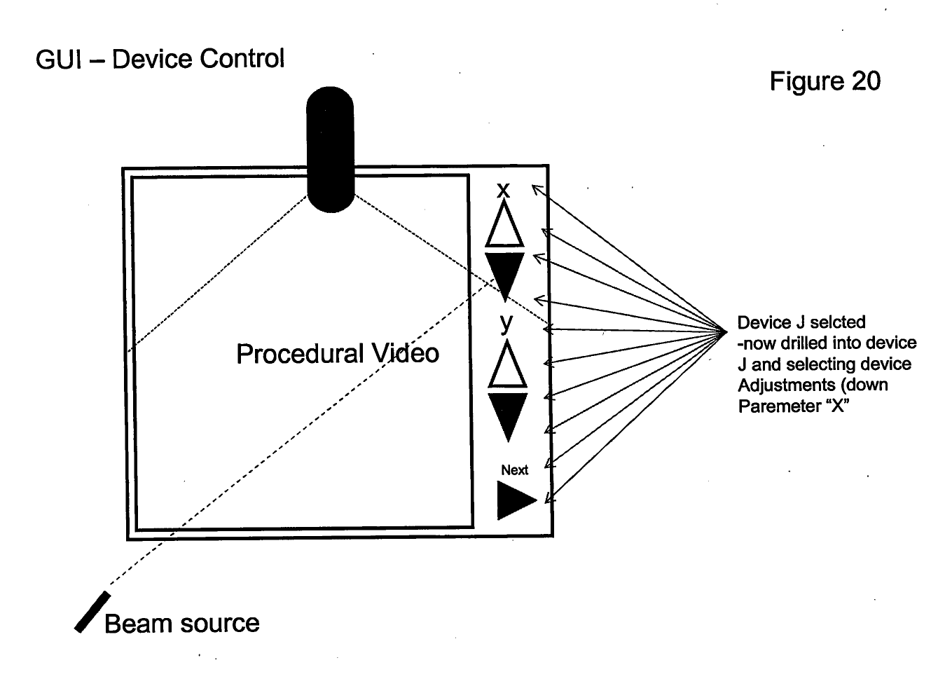

FIG. 20 illustrates device parameters altered using arrows and the combination of aiming the beam source and clicking a foot pedal as illustrated in FIG. 18.

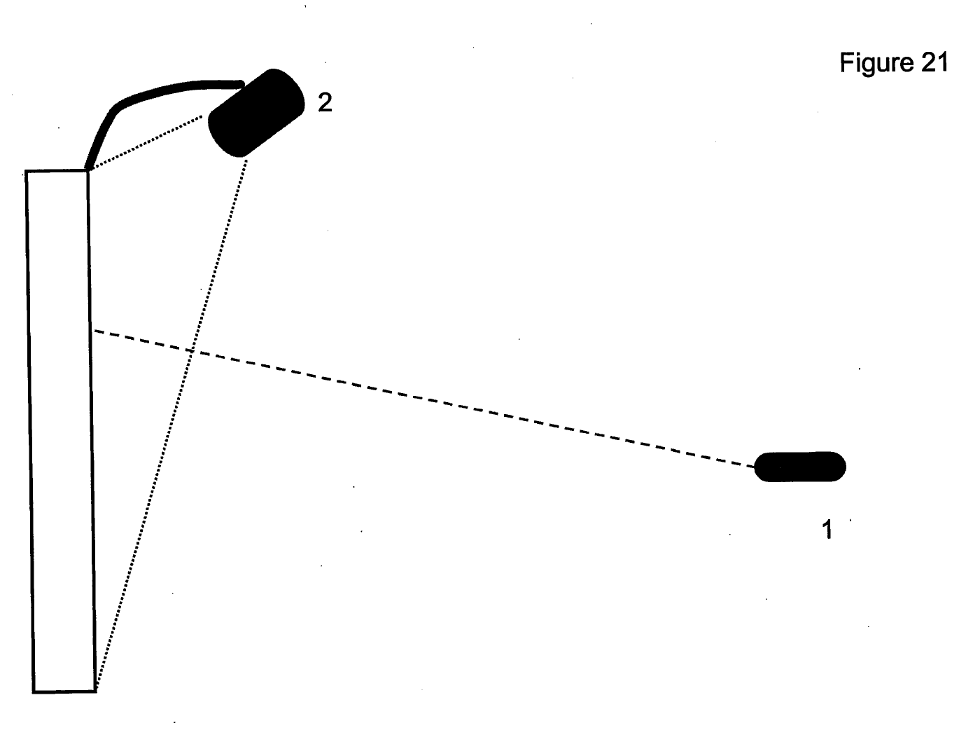

FIG. 21 illustrates a side view of low profile camera mounted to the display and the beam aimed at the display

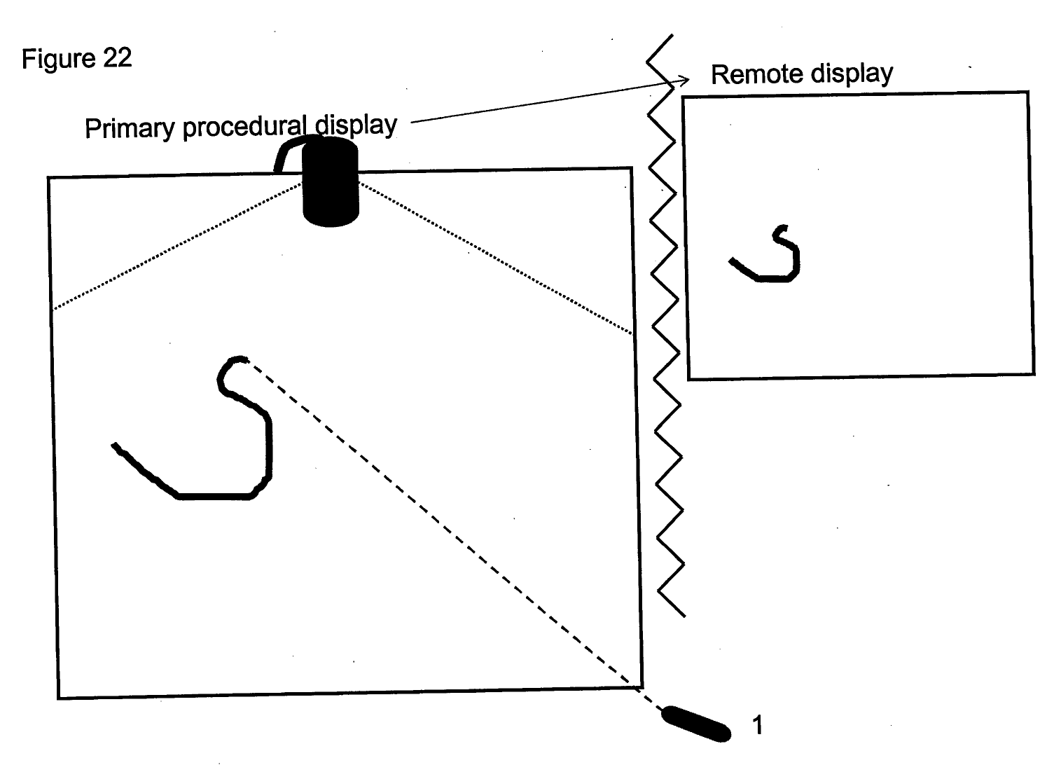

FIG. 22 illustrates a side view of low profile camera mounted to the display and the beam aimed at the display

FIG. 23 illustrates the aspect correction system that would correct for the trapezoidal image detected by the camera due to its position in relation to the display. FIG. 23 illustrates how a slightly trapezoidal image orientation due to off center camera placement could be corrected using a software algorithm that would correct the image for translation to a standard 4:3 or 16:9 aspect ratio.

### Medical Device Control

The third portion of the system will provide a means for a sterile clinician to control procedural devices in an easy and quick, yet hands free and centralized fashion. The ability to maximize the efficiency of the operation and minimize the time a patient is under anesthesia is important to the best patient outcomes. It is common for surgeons, cardiologists or radiologists to verbally request adjustments be made to certain medical devices and electronic equipment used in the procedure outside the sterile field. It is typical that he or she must rely on another staff member to make the adjustments he or she needs to settings on devices such as cameras, bovies, surgical beds, shavers, insufflators, injectors, to name a few. In many circumstances, having to command a staff member to make a change to a setting can slow down a procedure because the non-sterile staff member is busy with another task. The sterile physician cannot adjust non-sterile equipment without compromising sterility, so he or she must often wait for the non-sterile staff member to make the requested adjustment to a certain device before resuming the procedure.

The same system described in the previous section that allows a user to use the beam source and beam detector to regenerate a pointer overlay could be coupled with a graphic user interface (GUI) and a concurrent switching method (i.e. a foot switch, etc) to allow the clinician to click through commands on the primary display (see, e.g., FIG. 18). In one embodiment, a graphic user interface (GUI) could appear on the procedural video display when activated, such as when the user tilts his or her head twice to awaken it or steps on a foot switch provided with the system. Or it is possible that a right head tilt wakes up the system, and a left head tilt simply activates the beam source. When the overlay (called device control GUI overlay) appears on the screen it shows button icons representing various surgical devices and the user can use the beam source, in this case a laser beam, to aim at the button icons. Once the laser is over the proper button icon, a foot switch, or other simultaneous switch method can be activated, effectively acting like a mouse click on a computer (See FIGS. 19 and 20). For example a user can “wake up” the system, causing a the device control GUI overlay to pop up that lists button icons on the screen, each one labeled as a corresponding procedural medical device. The user can point the laser at the correct box or device and click a foot pedal (or some other concurrent control—like voice control, waistband button, etc) to make a selection, much like clicking a mouse on a computer. The sterile physician can then select “insufflator, for example” The subsequent screen shows arrow icons that can be clicked for various settings for the device that need to be adjusted (pressure, rate, etc.). In one iteration, the user can then can point the laser at the up arrow and click the foot pedal repeatedly until the desired setting is attained.

In one embodiment, components of the inventive system could be coupled with existing robotic endoscope holders to “steer” a rigid surgical endoscopic camera by sending movement commands to the robotic endoscope holding arm (provided separately, i.e. AESOP by Computer Motion). The endoscope is normally held by an assistant nurse or resident physician. There are robotic and mechanical scope holders currently on the market and some have even had been introduced with voice control. However, voice control systems have often proven cumbersome, slow and inaccurate. This embodiment would employ a series of software and hardware components to allow the overlay to appear as a crosshair on the primary procedural video screen. The user could point the beam source at any part of the quadrant and click a simultaneous switch, such as a foot pedal, to send movement commands to the existing robotic arm, which, when coupled with the secondary trigger (i.e., a foot switch, waist band switch, etc.) would send a command to adjust the arm in minute increments in the direction of the beam source. It could be directed by holding down the secondary trigger until the desired camera angle and position is achieved and then realeased. This same concept could be employed for surgical bed adjustments by having the overlay resemble the controls of a surgical bed. The surgical bed is commonly adjusted during surgery to allow better access to the anatomy. Using the combination of the beam source, in this case a laser, a beam detecting sensor such as a camera, a control system GUI overlay processing unit and beam source processor, and a device control interface unit, virtually any medical device could be controlled through this system. Control codes would be programmed into the device control interface unit, and most devices can be connected using an RS-232 interface, which is the is a standard for serial binary data signals connecting between a DTE (Data Terminal Equipment) and a DCE (Data Circuit-terminating Equipment). The present invention while described with reference to application in the medical field can be expanded/modified for use in other fields. Another use of this invention could be in helping those who are without use of their hands due to injury or handicap or for professions where the hands are occupied and hands free interface is desired.

Although the invention has been described with reference to the above examples, it will be understood that modifications and variations are encompassed within the spirit and scope of the invention. Accordingly, the invention is limited only by the following claims along with their full scope of equivalents.

What is claimed is:

1. A system for communication during surgical or other procedures, the system comprising: a resilient mounting piece adapted to be received on a user's head, a laser light device coupled to the headpiece and configured for selectively directing attention to a particular object or location.

2. The system of claim 1, wherein the mounting piece is adapted to be placed around the back of the user's head.

3. The system of claim 1, comprising a switch configured to selectively activate the laser light device without requiring the use of a user's hands.

4. The system of claim 3, wherein activation includes movement of the user's head, which is detected by a sensor that triggers the switch to the beam emitting device.

5. The system of claim 3, comprising a timer adapted to turn off the laser light automatically.

6. The system of claim 3, wherein the switch is adapted to turn off the laser light via a second motion of the user's head.

7. A method for communicating during surgical or other procedures, comprising:
providing a communication device positioned on a user's head, the device comprising a resilient mounting piece adapted to be received on a user's head, a laser light device coupled to the headpiece and configured for selectively directing attention to a particular object or location; and
directing light from the laser device to the object or location by positioning of the user's head so as to direct attention to the object or location.

8. A kit providing a system for communication during surgical or other procedures, the kit comprising: a laser light device adapted for coupling to a headpiece worn by a user; a switch connectible to the laser light device so as to enable activation of the laser light device; and instructions for assembling the laser light device, switch and a headpiece, the assembly configured for activating the laser light device without requiring use of the user's hands and, when worn by the user, selectively directing attention to a particular object or location by positioning of the user's head.

9. The kit of claim 8, further comprising a headpiece.

10. The kit of claim 8, wherein headpiece comprises a user's eyewear.

11. A system for overlaying a video image with a generated pointer image, the system comprising:
a detector positionable to detect a location of a beam directed from a remote source and onto an image of a first display; and
an image processing unit coupled with the detector, the image processing unit having one or more inputs for receiving image data of the image of the first display and signal comprising beam location data, the image processing unit further adapted overlay beam location data with the image data and output to a second display a combined image signal comprising the image from the first display having an indicator image corresponding to the location of the beam directed from the remote source.

12. The system of claim 11, further comprising a video camera for capturing the video image of a target and coupled to the first display so as to display video images on the first display.

13. The system of claim 11, wherein the first display comprises a local video display for displaying the video image, and wherein the detector is coupled with the local video display so as to detect reflected light indicative of the location of a beam on the local video display.

14. The system of claim 11, wherein the beam source comprises a laser beam source held or worn by a user.

15. The system of claim 11, wherein the beam source comprises a communication system of claim 1.

16. The system of claim 11, wherein the second display comprises a remote video display positioned at a location different from the location of the first display.

17. The system of claim 11, wherein the detector is directly coupled to the first display.

18. The system of claim 11, wherein the detector comprises a charge-coupled device (CCD).

19. The system of claim 11, further comprising the second display.

20. A method for overlaying a video image with a generated pointer image, the method comprising:
displaying a video image on a first display;
directing a beam source on an image generated on the first display;
detecting the location of the beam on the displayed video image using a detector positioned remotely from the beam source; and
generating at a second display a combined image comprising the image from the first display having an indicator image corresponding to the location of the beam directed from the beam source.

21. The method of claim 19, wherein detecting the location of the beam comprises detecting light reflected from a surface of the first display as the beam is directed to the surface of the first display.

22. The method of communication comprising:
detecting with a camera or infrared detecting sensor both a beam incident on a display screen and an image being displayed on the screen;
processing the detected incident beam and displayed image so as to separate the captured beam location from the rest of the displayed image;
processing the separated captured beam location so as to combine the separated captured beam location with image data of the displayed image and produce a combined image of the displayed image and the beam location that can be displayed on a remote display monitor.

23. The method of claim 22, wherein the location of the beam is configured to command operation of a device coupled with a graphical user interface overlay by locating a beam source at a location of the screen in combination with activating a switch or foot-switch.

24. The method of claim 22, wherein the beam source is utilized in combination with a graphic user interface and combined with a secondary switching mechanism that enables interface and adjustments to multiple medical devices linked to the system by aiming the beam source at specific areas of the primary procedural display as dictated by the graphic user interface and using the secondary switch as a mouse click operation that sends commands to said linked devices.

25. The method of claim 23, wherein a beam source sends a beam at a display and a beam detecting sensor aimed at said display detects the location of said beam source where a secondary switch may be used in combination with the beam aimed at a precise location of a graphic user interface overlay to send a signal to a control system interface generating commands to a computer.

26. A system for sending commands to a computer/device without the use of ones hands, the system comprising: a laser light device reflected at a display; a camera or set of cameras aimed at the display, a graphic user interface, and a computer.

27. The method of claim 22, comprising converting a laser beam reflected at a video display into a computer animated mouse pointer
